(19) United States
(12) Patent Application Publication
(10) Pub. No.: US 2026/0119548 A1
(43) Pub. Date: Apr. 30, 2026

(54) SEMANTIC DATA TRANSLATION WITH SELECTIVE METADATA MERGING

(71) Applicant: Snowflake Inc., Bozeman, MT (US)

(72) Inventors: Rachel Frances Blum, South Orange, NJ (US); Srilakshmi Chintala, Seattle, WA (US); Christopher T. Nivera, Santa Clara, CA (US); Jason Summer, Chicago, IL (US)

(21) Appl. No.: 18/929,393

(22) Filed: Oct. 28, 2024

(51) Int. Cl. G06F 16/33

(52) U.S. Cl. CPC G06F 16/3344

(57) ABSTRACT

Various example embodiments described herein provide for systems, methods, devices, instructions, and like for translation to semantic data for a schema of a data store with selective metadata merging, where the semantic data can enable generation of a structured language data query for the data store based on a natural language question. In particular, some example embodiments access existing non-compatible data that describes a data store schema of a data store, access existing compatible semantic data or generate (new) compatible semantic data that describes the data store schema, and compare metadata between one or more structural elements of the existing non-compatible data and one or more corresponding structural elements of the (accessed/generated) compatible semantic data to selectively merge metadata into the compatible semantic data.

### TECHNICAL FIELD

Embodiments described herein relate to data systems and, more particularly, to systems, methods, devices, and instructions for translation to semantic data for a schema of a data store with selective metadata merging, where the semantic data can enable generation of a structured language data query for the data store based on a natural language question.

### BACKGROUND

Traditionally, interacting with large datasets has involved substantial technical expertise, particularly in database query languages such as structured query language (SQL). This involvement of technical expertise has limited the ability of certain users, such as business users, who are typically not trained in these technical skills, to directly engage with data systems to extract desired data or valuable insights (e.g., business insights) based on stored data.

The advent of natural language processing (NLP) technologies has begun to shift this landscape. Additionally, the integration of artificial intelligence (AI) technologies, such as Large Language Models (LLMs), into data systems has allowed users with little to no technical expertise to interact with databases through natural language. This development has significantly lowered the barrier to entry for business users, enabling them to pose questions to databases in plain language without the need for understanding complex query syntax.

### BRIEF DESCRIPTION OF THE SEVERAL VIEWS OF THE DRAWINGS

Various ones of the appended drawings merely illustrate various example embodiments of the present disclosure and should not be considered as limiting its scope. In the drawings, which are not necessarily drawn to scale, like numerals may describe similar components in different views. To easily identify the discussion of any particular element or act, the most significant digit or digits in a reference number refer to the figure number in which that element is first introduced.

FIG. 1 illustrates an example computing environment comprising a database system in the example form of a network-based database system that includes a semantic data translation system with selective metadata merging, according to some example embodiments of the present disclosure.

FIG. 2 is a block diagram illustrating components of a compute service manager, according to some example embodiments of the present disclosure.

FIG. 3 is a block diagram illustrating components of an execution platform, according to some example embodiments of the present disclosure.

FIG. 4 is a flowchart of an example method for translation to semantic data for a schema of a data store with selective metadata merging, according to some example embodiments of the present disclosure.

FIG. 5 and FIG. 6 illustrate example graphical user interfaces, according to some example embodiments of the present disclosure.

FIG. 7 illustrates an example of non-compatible semantic data that can be processed by a semantic data translation system, according to some example embodiments of the present disclosure.

FIG. 8 illustrates an example of compatible semantic data that can be generated by a semantic data translation system, according to some example embodiments of the present disclosure.

FIG. 9A and FIG. 9B illustrate an example graphical user interface, according to some example embodiments of the present disclosure.

FIG. 10 illustrates a diagrammatic representation of a machine in the form of a computer system within which a set of instructions can be executed for causing the machine to perform any one or more of the methodologies discussed herein, according to some example embodiments of the present disclosure.

### DETAILED DESCRIPTION

Reference will now be made in detail to specific embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In recent years, the field of data analytics has seen significant advancements in making complex data more accessible to business users. As noted, traditional business intelligence (BI) tools often require users to have specialized knowledge of query languages or rely heavily on data teams to extract insights from stored organization data (e.g., stored company data). This approach can create bottlenecks and limit the ability of business users to quickly obtain the information they need for decision-making. Concurrently, there has been a growing trend towards the use of semantic layers in data analytics. Semantic layers serve as an abstraction that translates complex data structures into business-friendly terms and concepts. Accordingly, many organizations have invested resources in developing semantic layers using various partner tools and platforms.

The current state of the art in data analytics involves efforts to bridge the gap between these semantic layers and more intuitive, natural language interfaces for data exploration. Some natural language query systems have emerged that offer conversational interfaces, allowing users to ask questions about their data in natural language, where the natural language question can comprise both business and non-business questions from a user to be answered by data (e.g., tabular or numerical data) stored on a data store. With respect to business questions, examples can include business questions relating to sales, such as “Which customer resulted in the highest sales yesterday,” “Give me a list of the top 5 customers by sales last month,” and “Which date had the highest sales in the summer of 2020.” These natural language query systems typically require some form of semantic data (e.g., a semantic model) or metadata to interpret user queries and translate them into appropriate structured language data queries for a database.

However, a challenge remains in leveraging existing, non-native semantic data (e.g., existing semantic models) with these natural language query systems, such as semantic data generated or managed using external or third-party systems. An example of an external/third-party system can include Data Build Tool (DBT), an open-source command-line tool that helps analysts and data engineers transform data within their data warehouse to enable users to write modular SQL queries that build data models. Without the ability to leverage existing, non-native semantic data, organizations have to rebuild their semantic data (e.g., semantic models) from scratch to work with new software tools (e.g., natural language query systems), which can be time-consuming and resource-intensive.

Various example embodiments described herein provide for systems, methods, devices, instructions, and like for translation to semantic data for a schema of a data store with selective metadata merging, where the semantic data can enable generation of a structured language data query for the data store based on a natural language question. According to various example embodiments, a semantic data translation system accesses existing non-compatible data (e.g., generated by a third-party or partner software tool, which can be stored in a source YAML file) that describes a schema of a data store (e.g., after being uploaded to the semantic data translation system). The semantic data translation system can either access existing compatible semantic data (e.g., stored in a target YAML file) for editing, or can generate (new) compatible semantic data that comprises initial content (e.g., template content) that describes the data store schema. For some example embodiments, the semantic data translation system compares metadata between one or more structural elements of the existing non-compatible data and one or more corresponding structural elements of the (accessed/generated) compatible semantic data to selectively merge metadata into the compatible semantic data. For various example embodiments, the semantic data translation system enables a user (e.g., engineer) to review the metadata comparison and select which metadata (e.g., metadata from the existing non-compatible data or metadata already existing in the compatible semantic data) is to be merged into the compatible semantic data for a given structural element. Additionally, for some example embodiments, the semantic data translation system enables a user to refine (e.g., edit) an output of the merge to a desired output, which can be saved as a final compatible semantic data that describes the data store schema. According to some example embodiments, the compatible semantic data is used by a data system to generate one or more structured language data queries for a data store based on a natural language question (e.g., from a business or non-business user).

As used herein, a natural language query system can refer to a data system configured to generate a structured language data query based on a natural language question and semantic data associated with a schema of a data store (e.g., database or the like). According to various example embodiments, semantic data comprises a semantic description of (e.g., semantic knowledge regarding) at least a portion of a database schema (or schema) of a data store, such as a database that supports database tables or database views. The data system can use semantic data with one or more large language models (LLMs) to interpret natural language inputs comprising one or more natural language questions (e.g., natural language queries), and to generate one or more corresponding structure language queries (e.g., expressed by a data definition language (DDL), such as structured query language (SQL)) that can be performed (e.g., executed) on a data store (e.g., database) to obtain one or more query responses (e.g., comprising numeric or tabular data), which can be provided to users as responses (e.g., natural language outputs) to the natural language inputs. In this way the natural language query system can implement natural language query-to-structured language data query processing. Semantic data (e.g., semantic model) can effectively provide business logic and context-specific information about a schema of data store, and can potentially bridge the gap between the technical implementation of a data store (e.g., database) and the business logic, which in turn can bridge the gap between natural language questions posed by users (e.g., business users) and structured language queries used to obtain data from the data store (e.g., a database). For example, the semantic data can comprise a semantic model that labels a database column not just by its name in the database, such as “cust_id,” but also provides a semantic description like “Customer ID,” along with a detailed explanation of what the customer ID represents in a business context. Such semantic data can enable a data system to understand and generate responses that are contextually relevant to user's natural language questions. Additionally, the semantic understanding provided by semantic data can improve the accuracy and precision of the generated structured language queries.

Natural language questions received as input to a data system (e.g., natural language query system) that uses semantic data can comprise both business and non-business questions from a user to be answered by data (e.g., tabular or numerical data) stored on a data store. With respect to business questions, examples can include business questions relating to sales, such as “Which customer resulted in the highest sales yesterday,” “Give me a list of the top 5 customers by sales last month,” and “Which date had the highest sales in the summer of 2020.” Examples can include various business questions relating to advertising, such as “How many total paid impressions do we have for demand partner X,” “What's the monthly average cost per click for advertiser Y,” and “What's the YOY change in revenue by paid impressions for publisher Z.” Examples can include various business questions relating to real estate, such as “Which zip has the highest number of occupied properties,” “Which states have the highest average amount of space occupied,” and “How many buildings were constructed last year and what was their square footage.”

For various example embodiments, semantic data comprises a semantic model that is a structured representation of at least the portion of the schema of the data store and that provides the semantic description of at least the portion of the schema. The semantic model can be defined by one or more logical tables, where an individual logical table of the one or more logical tables is a view of a data store table (e.g., database table) of the data store or a data store view (e.g., database view) of the data store, where the individual logical table comprises one or more logical columns. An individual logical column of the individual logical table references an underlying column of the data store table or the data store view, or an individual logical column of the individual logical table can comprise an expression that references one or more underlying columns of the data store table or the data store view and that defines a derived column. For example, logical tables of the semantic model can comprise one or more of dimensions (e.g., non-time dimensions), time dimensions, measures, and filters, which collectively can enhance a data system's understanding of the data structure and context of the schema of the data store. The semantic data (e.g., semantic model) can comprise descriptive names, synonyms (e.g., for columns), detailed explanations (e.g., free-form descriptions of tables or columns), or a combination, which can align more closely with business terminology and user understanding rather than technical schema or code syntax. The semantic data can define one or more entities, which can correspond to data structures in an underlying data store (e.g., database), such as tables or views in the data store. Entities can serve as a basis for defining dimensions, measures, and relationships between different data elements. Entities can provide an abstraction (e.g., business-friendly abstraction) of the underlying data structures in a data store, which can enable a natural language query system. The semantic data (e.g., semantic model) can be defined in a semantic data file (e.g., content of which is defined in a YAML format or the like), where each semantic data file can comprise a different semantic model. A given schema can be associated with an individual semantic dataset, such as an individual semantic data file. Two schemas can be associated with the same semantic dataset (e.g., the same semantic data file). Semantic data can provide a semantic description for less than all tables or views of a data store, and can provide a semantic description for less than all of a given table or view. For instance, semantic data can comprise a semantic description for only certain, relevant columns of a given table. For various example embodiments, the data store comprises a database, or the like, that can store and organize data according to a schema. Additionally, for some example embodiments, the data store comprises unstructured data.

Though data systems (for generating structured language data query based on a natural language question) are described herein with respect to business users and business use cases, some example embodiments can be used with non-business users (e.g., technical users) to generate high-precision structure language data queries (e.g., SQL queries) using natural language questions and semantic data, where the high-precision structure language data queries can be provided to the non-business user without automatic execution (e.g., so that a technical user can review and modify the SQL query prior to it be executed).

As used herein, a database schema (or schema) can comprise a logical description that defines how data is stored and organized within a database or a data store. A schema can define, for example, an arrangement of tables, fields (e.g., columns), relationships, and other elements. While a schema can serve as a blueprint that outlines how data is stored and organized within the database, a schema usually does not store the data itself. As used herein, a database can store and manage data in accordance with a schema. A database can include one or more schemas that define different ways data is organized and stored within the database.

As used herein, a dataset can refer to a data point or data records within a database or datastore. As used herein, a large-language model (LLM) can include, without limitation, a GPT model (e.g., GPT-4), a LLAMA model (e.g., LLAMA-2), a MISTRAL model, a Claude model (e.g., Claude 3) or another type of generative model (e.g., a proprietary or tailored, generative pre-trained transformer). Generally, an LLM comprises one or more transformer neural networks, which can be configured (e.g., trained) for general-purpose language generation or another language processing task. An LLM can be constructed using deep learning techniques, such as neural networks, and trained to understand, predict, and generate (as output data) language by learning patterns, semantics, syntax, and contextual meanings from input data. An LLM can operate by processing sequences of text and can perform various tasks, including text completion, translation, summarization, question answering, and dialogue generation, with the ability to generalize across languages and domains based on the scale of training data.

Using a semantic data translation system of some example embodiments automates a process of converting existing third-party or partner data (e.g., semantic data) into compatible semantic data (e.g., compatible semantic data model) that has a format (e.g., structural format) compatible for use by a data system, such as a natural language query system described herein. In this way, some example embodiments enable a user (e.g., engineer) to generate compatible semantic data by leveraging (e.g., repurposing existing, curated metadata within) existing third-party/partner data (e.g., organizations, such as companies, can maximize prior investments in semantic modeling with third-party/partner software tools, such as DBT or LOOKER). The use of a semantic data translation system described herein can reduce or avoid the need for manual extraction from existing third-party/partner data or replication (e.g., rebuilding) of compatible semantic data, which can be a time-consuming and error-prone process. The use of a semantic data translation system described herein can also enable an organization (e.g., a company) to adapt to various semantic layer third-party/partner software tools used by other organizations. Additionally, the use of a semantic data translation system described herein can enable the reuse of existing third-party/partner data that is not necessarily designed for natural language query-to-structured language data query processing and generate compatible semantic data that is designed for natural language query-to-structured language data query processing.

Reference will now be made in detail to various example embodiments of the present disclosure, examples of which are illustrated in the appended drawings. The present disclosure may, however, be embodied in many different forms and should not be construed as being limited to the examples set forth herein.

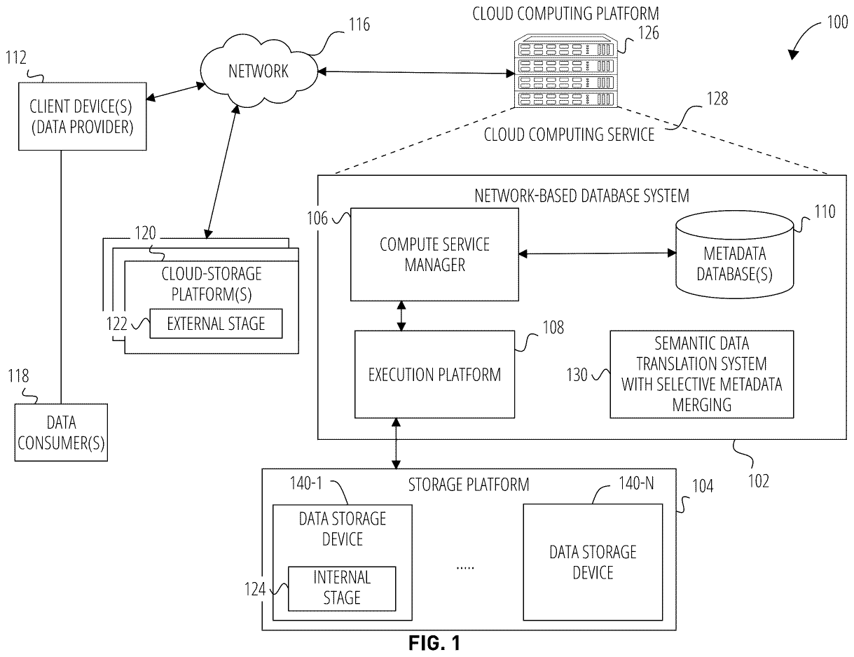

FIG. 1 illustrates an example computing environment 100 comprising a database system in the example form of a network-based database system 102 that includes a semantic data translation system 130 with selective metadata merging, according to some example embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some example embodiments, the computing environment 100 may include a cloud computing platform 126 with the network-based database system 102, and a storage platform 104 (also referred to as a cloud storage platform). The cloud computing platform 126 provides computing resources and storage resources that may be acquired (purchased) or leased and configured to execute applications and store data.

The cloud computing platform 126 may host a cloud computing service 128 that facilitates storage of data on the cloud computing platform 126 (e.g., data management and access) and analysis functions (e.g., SQL queries, analysis), as well as other processing capabilities (e.g., configuring replication group objects as described herein). The cloud computing platform 126 may include a three-tier architecture: data storage (e.g., storage platforms 104), an execution platform 108 (e.g., providing query processing), and a compute service manager 106 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 126 could also use a cloud-storage platform as what is referred to herein as an internal storage location concerning the data platform.

From the perspective of the network-based database system 102 of the cloud computing platform 126, one or more files that are stored at one or more storage locations are referred to herein as being organized into one or more of what is referred to herein as either “internal stages” or “external stages.” Internal stages (e.g., internal stage 124) are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 126 is in communication with the storage platforms 104 and cloud-storage platforms 120 (e.g., AWS®, Microsoft Azure Blob Storage®, or Google Cloud Storage). The network-based database system 102 is a network-based system used for reporting and analysis of integrated data from one or more disparate sources including one or more storage locations within the storage platform 104. The storage platform 104 comprises a plurality of computing machines and provides on-demand computer system resources such as data storage and computing power to the network-based database system 102.

The network-based database system 102 comprises a compute service manager 106, an execution platform 108, and one or more metadata databases 110. The network-based database system 102 hosts and provides data reporting and analysis services to multiple client accounts.

The compute service manager 106 coordinates and manages operations of the network-based database system 102. The compute service manager 106 also performs query optimization and compilation as well as managing clusters of computing services that provide compute resources (also referred to as “virtual warehouses”). The compute service manager 106 can support any number of client accounts such as end-users providing data storage and retrieval requests, system administrators managing the systems and methods described herein, and other components/devices that interact with compute service manager 106.

The compute service manager 106 is also in communication with a client device 112. The client device 112 corresponds to a user of one of the multiple client accounts supported by the network-based database system 102. A user may utilize the client device 112 to submit data storage, retrieval, and analysis requests to the compute service manager 106. Client device 112 (also referred to as remote computing device or user client device 112) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 126 (e.g., cloud computing service 128) by way of a network 116, such as the Internet or a private network. A data consumer 118 can use another computing device to access the data of the data provider (e.g., data obtained via the client device 112).

In the description below, actions are ascribed to users, particularly consumers and providers. Such actions shall be understood to be performed concerning client device (or devices) 112 operated by such users. For example, a notification to a user may be understood to be a notification transmitted to the client device 112, input or instruction from a user may be understood to be received by way of the client device 112, and interaction with an interface by a user shall be understood to be interaction with the interface on the client device 112. In addition, database operations (joining, aggregating, analysis, etc.) ascribed to a user (consumer or provider) shall be understood to include performing such actions by the cloud computing service 128 in response to an instruction from that user.

The compute service manager 106 is also coupled to one or more metadata databases 110 that store metadata about various functions and aspects associated with the network-based database system 102 and its users. For example, a metadata database 110 may include a summary of data stored in remote data storage systems as well as data available from a local cache. Additionally, a metadata database 110 may include information regarding how data is organized in remote data storage systems (e.g., the cloud storage platform 104) and the local caches. Information stored by a metadata database 110 allows systems and services to determine whether a piece of data needs to be accessed without loading or accessing the actual data from a storage device. In some example embodiments, metadata database 110 is configured to store account object metadata (e.g., account objects used in connection with a replication group object).

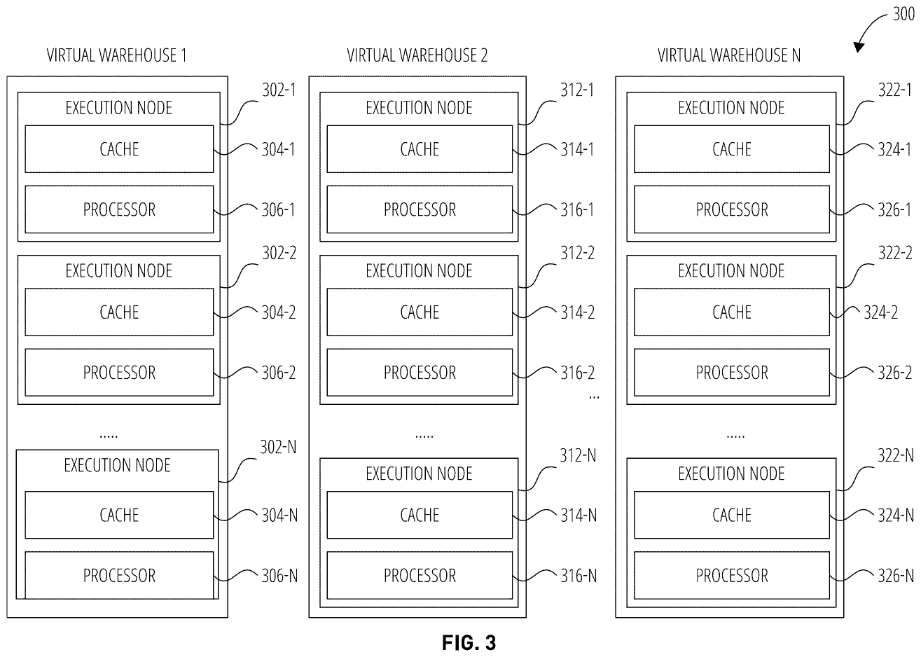

The compute service manager 106 is further coupled to the execution platform 108, which provides multiple computing resources that execute various data storage and data retrieval tasks. As illustrated in FIG. 3, the execution platform 108 comprises a plurality of compute nodes. The execution platform 108 is coupled to storage platform 104 and cloud-storage platforms 120. The storage platform 104 comprises multiple data storage devices 140-1 to 140-N. In some example embodiments, the data storage devices 140-1 to 140-N are cloud-based storage devices located in one or more geographic locations. For example, the data storage devices 140-1 to 140-N may be part of a public cloud infrastructure or a private cloud infrastructure. The data storage devices 140-1 to 140-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like. In some example embodiments, at least one internal stage 124 may reside on one or more of the data storage devices 140-1-140-N, and at least one external stage 122 may reside on one or more of the cloud-storage platforms 120.

In some example embodiments, communication links between elements of the computing environment 100 are implemented via one or more data communication networks. These data communication networks may utilize any communication protocol and any type of communication medium. In some example embodiments, the data communication networks are a combination of two or more data communication networks (or sub-networks) coupled to one another. In alternative embodiments, these communication links are implemented using any type of communication medium and any communication protocol.

The compute service manager 106, metadata database(s) 110, execution platform 108, and storage platform 104, are shown in FIG. 1 as individual discrete components. However, each of the compute service manager 106, metadata database(s) 110, execution platform 108, and storage platform 104 may be implemented as a distributed system (e.g., distributed across multiple systems/platforms at multiple geographic locations). Additionally, each of the compute service manager 106, metadata database(s) 110, execution platform 108, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 106. These jobs are scheduled and managed by the compute service manager 106 to determine when and how to execute the job. For example, the compute service manager 106 may divide the job into multiple discrete tasks and may determine what data is needed to execute each of the multiple discrete tasks. The compute service manager 106 may assign each of the multiple discrete tasks to one or more nodes of the execution platform 108 to process the task. The compute service manager 106 may determine what data is needed to process a task and further determine which nodes within the execution platform 108 are best suited to process the task. Some nodes may have already cached the data needed to process the task and, therefore, be a good candidate for processing the task. Metadata stored in a metadata database 110 assists the compute service manager 106 in determining which nodes in the execution platform 108 have already cached at least a portion of the data needed to process the task. One or more nodes in the execution platform 108 process the task using data cached by the nodes and, if necessary, data retrieved from the storage platform 104. It is desirable to retrieve as much data as possible from caches within the execution platform 108 because the retrieval speed is typically much faster than retrieving data from the storage platform 104.

As shown in FIG. 1, the cloud computing platform 126 of the computing environment 100 separates the execution platform 108 from the storage platform 104. In this arrangement, the processing resources and cache resources in the execution platform 108 operate independently of the data storage devices 140-1 to 140-N in the storage platform 104. Thus, the computing resources and cache resources are not restricted to specific data storage devices 140-1 to 140-N. Instead, all computing resources and all cache resources may retrieve data from, and store data to, any of the data storage resources in the storage platform 104.

As also shown, the network-based database system 102 comprises a semantic data translation system 130 configured to translate existing non-compatible data (e.g., generated by a third-party or partner software tool) describing a schema of a data store (such as a database of the network-based database system 102) to data that is selectively merged into a new or existing compatible semantic data (e.g., compatible semantic model) in accordance with various example embodiments described herein. The resulting compatible semantic data can be used by a natural language query system implemented using the network-based database system 102.

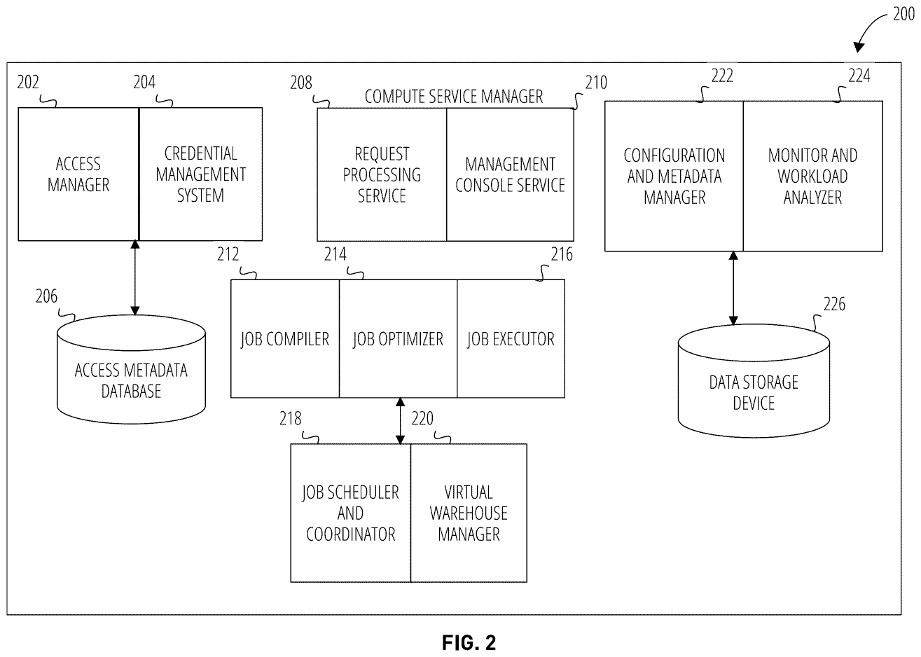

FIG. 2 is a block diagram 200 illustrating components of the compute service manager 106, according to some example embodiments of the present disclosure. As shown in FIG. 2, the compute service manager 106 includes an access manager 202 and a credential management system 204 coupled to access access metadata database 206, which is an example of the metadata database(s) 110.

Access manager 202 handles authentication and authorization tasks for the systems described herein. The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service execution platform 108 may determine the data to process a received query (e.g., a data storage request or data retrieval request). The data can be stored in a cache within the execution platform 108 or in a data storage device in storage platform 104.

A management console service 210 supports access to various systems and processes by administrators and other system managers. Additionally, the management console service 210 may receive a request to execute a job and monitor the workload on the system.

The compute service manager 106 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 106.

A job scheduler and coordinator 218 sends received jobs to the appropriate services or systems for compilation, optimization, and dispatch to the execution platform 108. For example, jobs can be prioritized and then processed in that prioritized order. In an embodiment, the job scheduler and coordinator 218 determines a priority for internal jobs that are scheduled by the compute service manager 106 with other “outside” jobs such as user queries that can be scheduled by other systems in the database but may utilize the same processing resources in the execution platform 108. In some example embodiments, the job scheduler and coordinator 218 identifies or assigns particular nodes in the execution platform 108 to process particular tasks. A virtual warehouse manager 220 manages the operation of multiple virtual warehouses implemented in the execution platform 108. For example, the virtual warehouse manager 220 may generate query plans for executing received queries.

Additionally, the compute service manager 106 includes a configuration and metadata manager 222, which manages the information related to the data stored in the remote data storage devices and in the local buffers (e.g., the buffers in execution platform 108). The configuration and metadata manager 222 uses metadata to determine which data files need to be accessed to retrieve data for processing a particular task or job. A monitor and workload analyzer 224 oversees processes performed by the compute service manager 106 and manages the distribution of tasks (e.g., workload) across the virtual warehouses and execution nodes in the execution platform 108. The monitor and workload analyzer 224 also redistributes tasks, as needed, based on changing workloads throughout the cloud computing platform 126 and may further redistribute tasks based on a user (e.g., “external”) query workload that may also be processed by the execution platform 108. The configuration and metadata manager 222 and the monitor and workload analyzer 224 are coupled to a data storage device 226. Data storage device 226 in FIG. 2 represents any data storage device within the storage platform 104. For example, data storage device 226 may represent buffers in execution platform 108, storage devices in cloud storage platform 104, or any other storage device.

As described in embodiments herein, the compute service manager 106 validates all communication from an execution platform (e.g., the execution platform 108) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1) may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

FIG. 3 is a block diagram 300 illustrating components of the execution platform 108, according to some example embodiments of the present disclosure. As shown in FIG. 3, the execution platform 108 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 108 can add new virtual warehouses and drop existing virtual warehouses in real-time based on the current processing needs of the systems and users. This flexibility allows the execution platform 108 to quickly deploy large amounts of computing resources when needed without being forced to continue paying for those computing resources when they are no longer needed. All virtual warehouses can access data from any data storage device (e.g., any storage device in storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 140-1 to 140-N shown in FIG. 1. Thus, the virtual warehouses are not necessarily assigned to a specific data storage device 140-1 to 140-N and, instead, can access data from any of the data storage devices 140-1 to 140-N within the storage platform 104. Similarly, each of the execution nodes shown in FIG. 3 can access data from any of the data storage devices 140-1 to 140-N. In some example embodiments, a particular virtual warehouse or a particular execution node can be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse N includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some example embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some example embodiments, the caches are implemented using high-speed memory devices that provide fast access to the cached data. Each cache can store data from any of the storage devices in the storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some example embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 108, the virtual warehouses can be implemented using multiple computing systems at multiple geographic locations. For example, virtual warehouse 1 can be implemented by a computing system at a first geographic location, while virtual warehouses 2 and N are implemented by another computing system at a second geographic location. In some example embodiments, these different computing systems are cloud-based computing systems maintained by one or more different entities.

Additionally, each virtual warehouse is shown in FIG. 3 as having multiple execution nodes. The multiple execution nodes associated with each virtual warehouse can be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 108 is also fault tolerant. For example, if one virtual warehouse fails, that virtual warehouse is quickly replaced with a different virtual warehouse at a different geographic location. A particular execution platform 108 may include any number of virtual warehouses. Additionally, the number of virtual warehouses in a particular execution platform is dynamic, such that new virtual warehouses are created when additional processing and/or caching resources are needed. Similarly, existing virtual warehouses can be deleted when the resources associated with the virtual warehouse are no longer useful.

In some example embodiments, the virtual warehouses may operate on the same data in storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

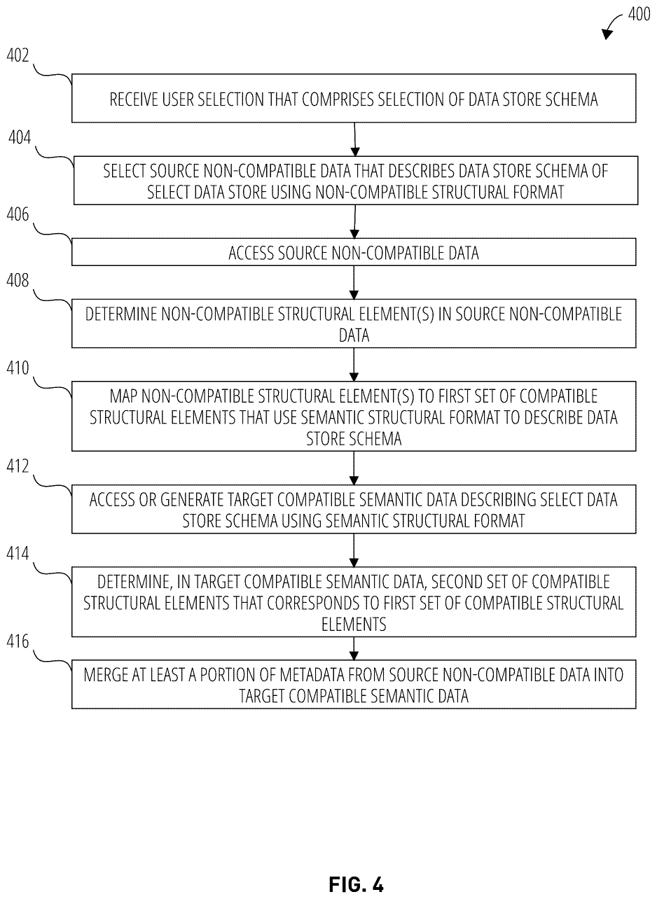

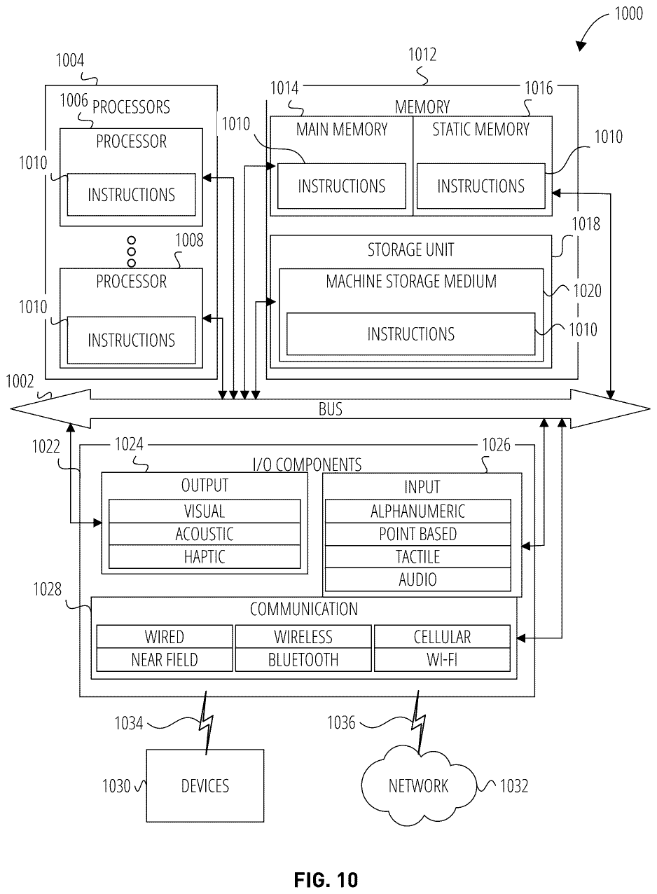

FIG. 4 is a flowchart of an example method 400 for translation to semantic data for a schema of a data store with selective metadata merging, according to some example embodiments of the present disclosure. Method 400 may be embodied in computer-readable instructions for execution by one or more hardware components (e.g., one or more processors) such that the operations of method 400 can be performed by components of the semantic data translation system 130 or the network-based database system 102, such as a network node (e.g., the semantic data translation system 130 executing on a network node of the compute service manager 106) or a computing device (e.g., client device 112), one or both of which may be implemented as machine 1000 of FIG. 10 performing the disclosed functions. Accordingly, method 400 is described below, by way of example with reference thereto. However, it shall be appreciated that method 400 may be deployed on various other hardware configurations and is not intended to be limited to deployment within the network-based database system 102.

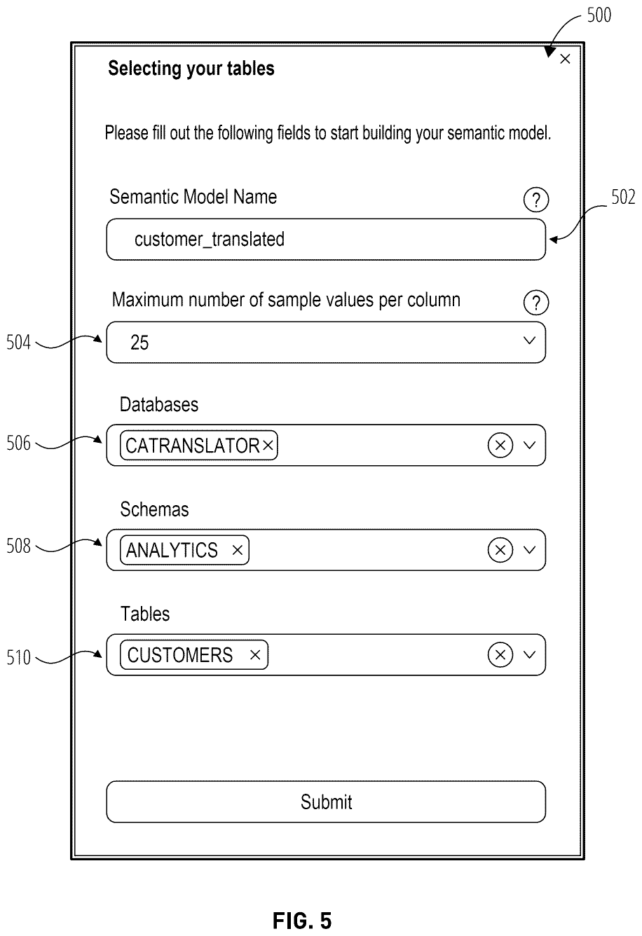

At operation 402, a processor (e.g., implementing the semantic data translation system 130) receives a user selection comprising a selection of a data store schema of a select data store, such as a database of the network-based database system 102. For some example embodiments, the user selection comprises a selection of one or more tables of the data store (e.g., database). Depending on the example embodiment, the processor can receive the user selection by way of a graphical user interface, which the processor can cause to be displayed on a client device (e.g., 112). An example of such a graphical user interface is illustrated and described with respect to FIG. 5.

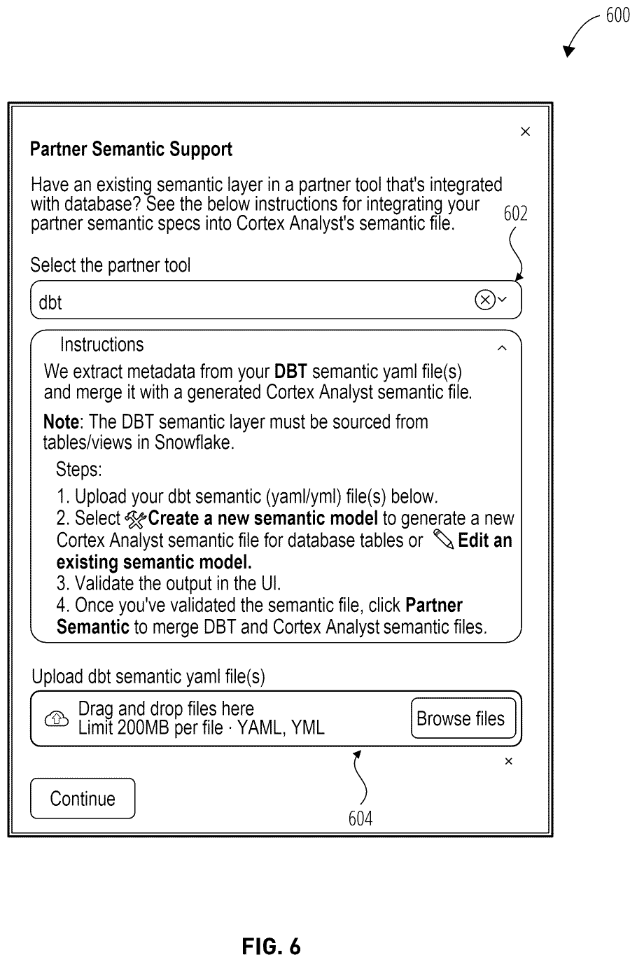

During operation 404, the processor selects source non-compatible data that describes the data store schema of the select data store. By selecting the source non-compatible data, the user (e.g., of an organization) can leverage existing data to generate new compatible semantic data (or edit existing compatible semantic data) that is compatible for use with the target system (e.g., natural language query system). For various example embodiments, the selection of the source non-compatible data comprises receiving (e.g., as an upload) the source non-compatible data (e.g., DBT file) by way of a graphical user interface, such graphical user interface 600 of FIG. 6. The source non-compatible data can be received (e.g., uploaded) as a file comprising data in YAML format.

During operation 406, the processor accesses the source non-compatible data that describes the data store schema of the select data store. For some example embodiments, the source non-compatible data uses a structural format that is not compatible for use by a target data system to generate one or more structured language data queries (e.g., SQL queries) for the select data store based on a natural language question. For various example embodiments, the source non-compatible data is generated or managed by a third-party or partner software tool, such as one that generates metadata or semantic data for a data store schema. Depending on the example embodiment, the source non-compatible data can comprise semantic data for the data store schema of the select data store, where the semantic data is not compatible for use (e.g., usable) by the target data system.

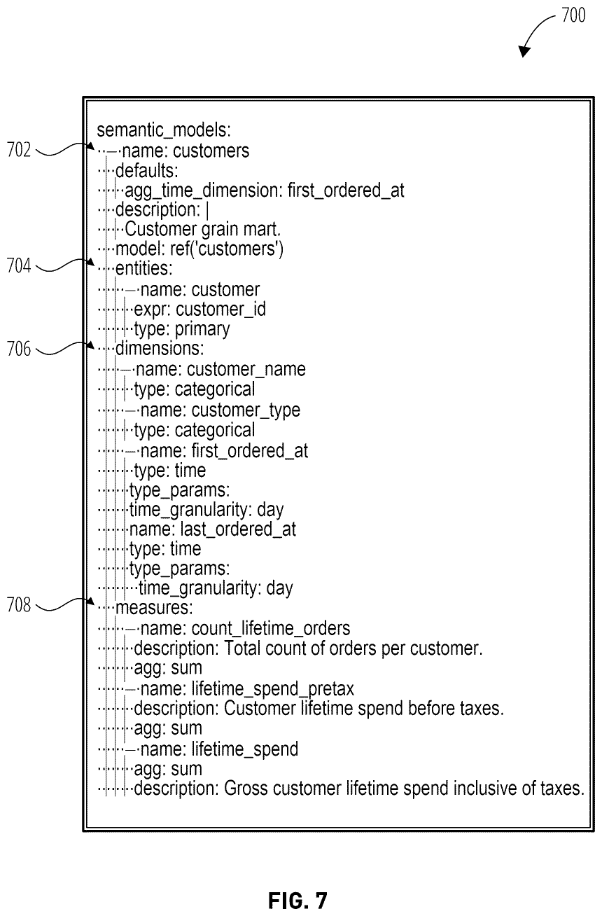

For operation 408, the processor determines (e.g., identifies) a set of non-compatible structural elements in the source non-compatible data. In doing so, the processor can extract information from the source non-compatible data that is relevant (e.g., usable) for comparing and merging (e.g., integrating or incorporating) metadata from the source non-compatible data into new or existing compatible semantic data. The non-compatible structural elements determined (e.g., identified) during operation 406 can vary between source non-compatible data having different structural formats. Additionally, the non-compatible structural elements determined (e.g., identified) are ones relevant to (e.g., useable by) various example embodiments for comparison and merging processes described herein. According to various example embodiments, the set of non-compatible structural elements using one or more keywords that are associated with the structural format of the source non-compatible data and that are associated with structural elements relevant to (e.g., useable by) the comparison and merging processes described herein. For some example embodiments, the set of non-compatible structural elements comprises at least one of an entity, a measure, or a dimension. Information for entities can be determined (e.g., identified) in the source non-compatible data using the keyword “entity” or “entities,” dimensions can be determined (e.g., identified) in the source non-compatible data using the keyword “dimension” or “dimensions,” and measures can be determined (e.g., identified) in the source non-compatible data using the keyword “measure” or “measures.” FIG. 7 illustrates example non-compatible semantic data 700, such as the content of a DBT file, that provides a semantic description of an example data store schema. As shown, the non-compatible semantic data 700 comprises entities 704, dimensions 706, and measures 708. Table 1 provides instructions for creating an example data object that is being semantically described by the non-compatible semantic data 700 of FIG. 7.

TABLE 1
create database CATRANSLATOR;
create schema CATRANSLATOR.ANALYTICS;
create stage CATRANSLATOR.ANALYTICS.DATA;
create or replace table CATRANSLATOR.ANALYTICS.CUSTOMERS (
CUSTOMER_ID VARCHAR(16777216),
CUSTOMER_NAME VARCHAR(16777216),
COUNT_LIFETIME_ORDERS NUMBER(18,0),
FIRST_ORDERED_AT DATE,
LAST_ORDERED_AT DATE,
LIFETIME_SPEND_PRETAX NUMBER(22,2),
LIFETIME_TAX_PAID NUMBER(22,2),
LIFETIME_SPEND NUMBER(22,2),
CUSTOMER_TYPE VARCHAR(9)
);

At operation 410, the processor maps the set of non-compatible structural elements (e.g., determined/identified during operation 406) to a first set of compatible structural elements that uses a semantic structural format to describe the data store schema. For some example embodiments, the semantic structural format (of the first set of compatible structural elements) is compatible for use by the target data system to generate one or more structured language data queries for the select data store based on a natural language question. According to various example embodiments, the first set of compatible structural elements enables a subsequent comparison of the source non-compatible data and new/existing compatible semantic data. During operation 410, one or more non-compatible structural elements are mapped to equivalent one or more compatible structural elements. With respect to mapping non-compatible structural elements of a DBT file to compatible structural elements of the (compatible) semantic structural format, an entity identified in a DBT file can be mapped to a dimension or a measure (of the semantic structural format), a dimension in a DBT file can be mapped to a non-time dimension or a time dimension (of the semantic structural format), and a measure in a DBT file can be mapped to a measure (of the semantic structural format). The determined mappings can be saved as a data object (e.g., in a staging area), such as a session data object.

At operation 412, the processor either accesses existing target compatible semantic data that a user has selected to be modified (e.g., edited or updated) based on data from the source non-compatible data, or generates new target compatible semantic data. For various example embodiments, new/existing target compatible semantic data describes the data store schema using the semantic structural format that is compatible for use by the target data system to generate one or more structured language data queries for the select data store based on a natural language question. Additionally, for some example embodiments, the target compatible semantic data and the source non-compatible data describe the same data store schema. This enables various example embodiments to leverage (e.g., reuse or repurpose) portions of metadata from the source non-compatible data in the target compatible semantic data. The new/existing target compatible semantic data can be defined by one or more logical tables, wherein an individual logical table semantically describes a table of the select data store or a view of the select data store, where the individual logical table comprises one or more logical columns, and where an individual logical column semantically describes an underlying column of the table or the view. The individual logical column can be either a non-time dimension logical column capable of storing a categorical value, a time dimension logical column capable of storing a time value, or a measure logical column capable of storing a numerical value. Additionally, an individual logical column (of an individual logical table) can comprise an expression that references one or more underlying columns of the table or the view and that defines a derived column. The expression can comprise a structured language data query (e.g., SQL) expression used for filtering values.

The target compatible semantic data can comprise data in a YAML format. The existing target compatible semantic data or the new target compatible semantic data can be stored in a staging area. The new target compatible semantic data can be generated (e.g., from scratch) based on the data store schema using a proprietary or non-proprietary semantic model generation software, such as an Open Source Software (OSS) Semantic Model generator. The new target compatible semantic data generated during operation 412 can represent template semantic data (e.g., template semantic model) that is populated with initial metadata, which may or may not be replaced by metadata from the source non-compatible data during comparison and merging processes.

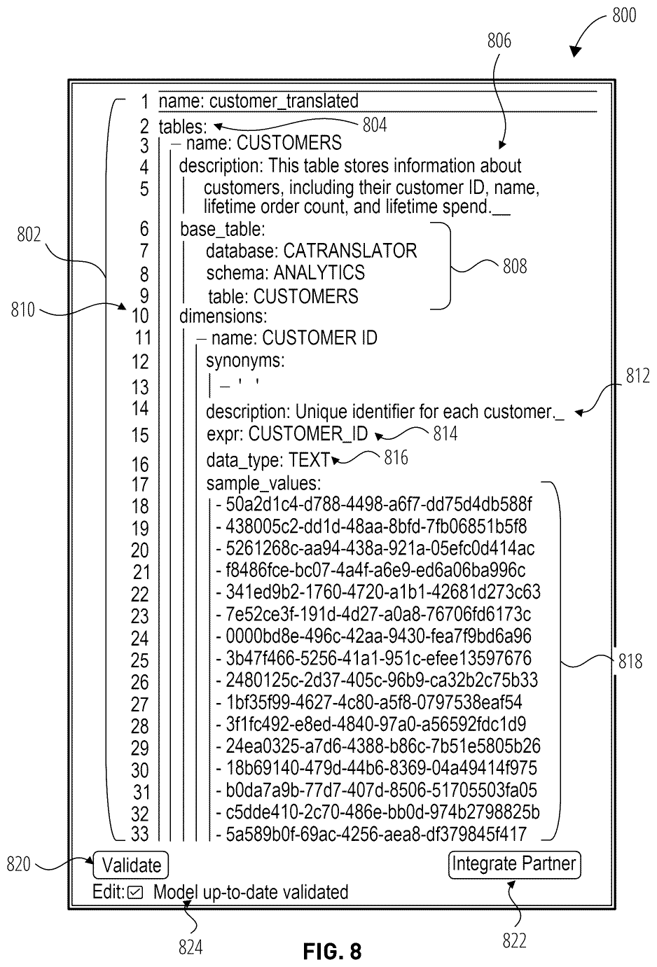

For some example embodiments, where the new target compatible semantic data is generated, operation 412 comprises the processor mapping a column of a table of the select data store to at least one of a non-time logical dimension, a time dimension logical column, or a measure logical column in the target compatible semantic data based on a data type of the column, the non-time dimension logical column being capable of storing a categorical value, the time dimension logical column being capable of storing a time value, date value, or both, and the measure logical column being capable of storing a numerical value. Generation of the new target compatible semantic data can comprise extracting, from the select data store, a comment or metadata for at least one of a table, a view, or a column of the select data store identified by the data store schema. Extracted metadata can be included as part of the new target compatible semantic data as is. Alternatively, or additionally, the processor can use a large-language model to generate, for the target compatible semantic data, a natural language description of the at least one of the table, the view, or the column based on the extracted comment or metadata, where the generated natural language description can then be included as part of the new target compatible semantic data. For instance, one or more portions of the extracted comment or metadata can be used in a prompt that is submitted to (as input) and processed by the large-language model to generate an output that includes the natural language description. In this way, some example embodiments can use a large-language model (e.g., prompt the LLM iteratively or all at once) to generate one or more natural language descriptions for each of multiple tables, views, or columns semantically described in the new target compatible semantic data. For some example embodiments, where a comment is extracted (from the select data store) for a table, a view, or a column, the comment is used in place of an LLM-generated natural language description for the table, the view, or the column. Further, to generate the new target compatible semantic data, the processor can obtain (e.g., retrieve), from the select data store, a select number of sample values from (values stored within) a column of a table of the select data store identified by the data store schema, where one or more sample values can be included as part of the target compatible semantic data. Alternatively, or additionally, the processor can use a set of large-language models to generate, for the target compatible semantic data, a natural language description of the column of the table of the select data store based on the select number of sample values. An example of generated compatible semantic data is illustrated and described with respect to FIG. 8.

For operation 414, the processor determines (e.g., identifies), in the (new/existing) target compatible semantic data, a second set of compatible structural elements that corresponds to the first set of compatible structural elements determined by operation 410. For some embodiments, a structural element the second set of compatible structural elements can comprise a non-time dimension, a time dimension, a measure, or the like.

During operation 416, the processor merges at least a portion of metadata from the source non-compatible data into the target compatible semantic data. For some example embodiments, operation 416 comprises using the first set of compatible structural elements (determined during operation 408) to compare first metadata from the source non-compatible data for the set of non-compatible structural elements with second metadata from the target compatible semantic data for the second set of compatible structural elements (determined during operation 414). For example, the processor can match a first compatible structural element of the first set of compatible structural elements with a second compatible structural element of the second set of compatible structural elements, where the first compatible structural element corresponds to a select non-compatible structural element of the set of non-compatible structural elements. To merge at least a portion of metadata from the source non-compatible data into the target compatible semantic data, the processor determines whether the source non-compatible data contains select metadata associated with the select non-compatible structural element. In response to determining that the source non-compatible data contains the select metadata, the processor can replace, in the target compatible semantic data, existing metadata for the second compatible structural element with the select metadata from the source non-compatible data. However, in response to determining that the source non-compatible data does not contain the select metadata, the process can cause existing metadata in the target compatible semantic data to be retained (e.g., not be replaced) for the second compatible structural element.

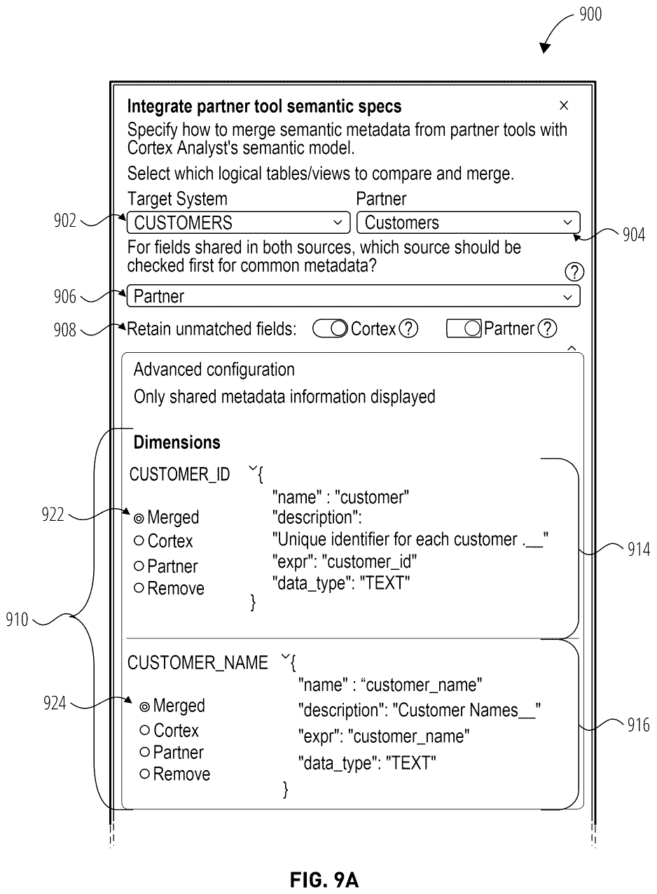

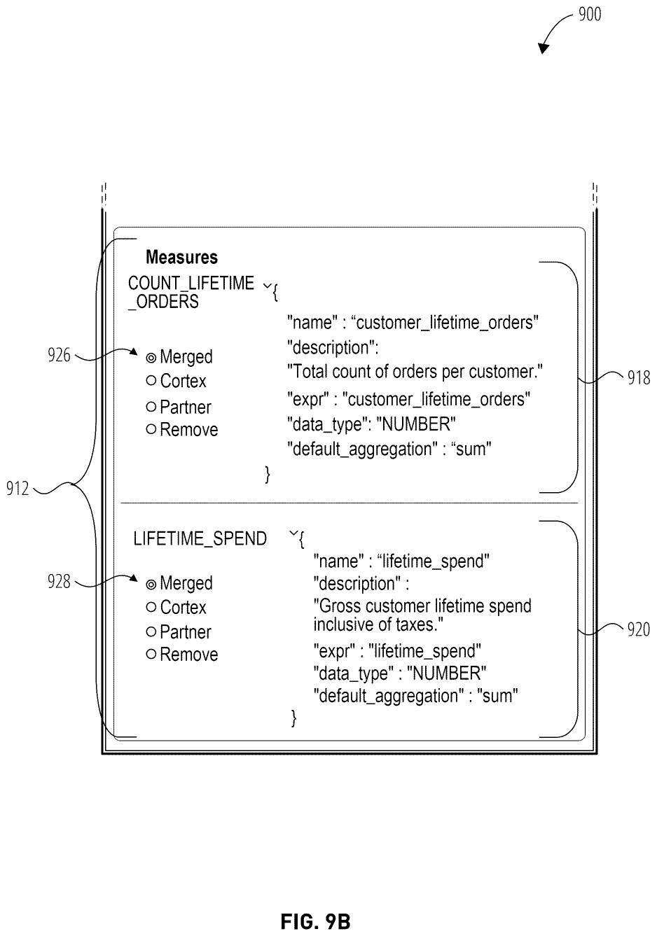

According to various example embodiments, during operation 416, a user (e.g., engineer) is able to review comparison and potential merger of metadata for different structural elements prior to the merger actually occurring. For instance, the process can cause a graphical user interface to be displayed on a client device (e.g., 112), where the graphical user interface enables a user at the client device to preview metadata within the new/existing target compatible semantic data after merger of one or more portions of metadata from the source non-compatible data based on selections according to default or user preferences. During the preview, the user can override one or more of the merger selections, or manually enter one or more modifications to metadata within the new/existing target compatible semantic data. An example of such a graphical user interface is illustrated and described with respect to FIG. 9A.

FIG. 5 and FIG. 6 illustrate example graphical user interfaces 500, 600 that can be used with various example embodiments of the present disclosure. Referring to FIG. 5, graphical user interface 500 represents an example graphical user interface that enables a user (e.g., engineer) at a client device (e.g., 112) to specify a name (in graphical user interface field 502) for new compatible semantic data to be generated by a semantic data translation system described herein, and specify a maximum number of sample values (in graphical user interface field 504) to be obtained from each column (of one or more specified tables) to be included in the new compatible semantic data. The graphical user interface 500 further enables the user to specify a data store (e.g., database) (in graphical user interface field 506), a schema (in graphical user interface field 508) of the specified data store, and one or more tables of the specified data store (in graphical user interface field 510) for which the new compatible semantic data. As shown, the user has specified a name of “customer_translated,” a maximum of 25 sample values are to be obtained from each column of each specified table, and specified a CUSTOMER table of a ANALYTICS schema of the CATRANSLATOR database.

Referring to FIG. 6, graphical user interface 600 represents an example graphical user interface that enables a user (e.g., engineer) at a client device (e.g., 112) to upload source non-compatible data (e.g., non-compatible semantic data, such as non-compatible semantic model) to a semantic data translation system described herein. Depending on the example embodiment, the source non-compatible data can be uploaded from a file or an external data source (e.g., cloud data source). As shown, graphical user interface element 602 enables a user to select what third-party/partner-software tool was used to generate the non-compatible data the user is meaning to upload to the semantic data translation system through the graphical user interface 600. In FIG. 6, the user has specified that DBT was used to generate the non-compatible data being uploaded by the user. The user can then use graphical user interface element 604 to upload a file (e.g., DBT file) comprising the non-compatible data.

FIG. 7 illustrates an example of non-compatible semantic data 700 that can be processed by a semantic data translation system, according to some example embodiments of the present disclosure. For some example embodiments, the non-compatible semantic data 700 represents data stored in a file, such as DBT file. As shown, the non-compatible semantic data 700 that describes a semantic model named “customers” (semantic model name 702) and that describes entities 704 (e.g., an entity named “customer” associated with a SQL expression “customer_id”), dimensions 706 (e.g., dimension “customer_type” of a data type “categorical,” dimension “first_ordered_at” of a data type “time,” dimension “last_ordered_at” of a data type “time,” and dimension “customer_name” of a data type “categorical”), and measures 708 (e.g., measure “count_lifetime_orders” with a natural language description “Total count of orders per customer.,” measure “lifetime_spend_pretax” with a natural language description “Customer lifetime spend before taxes.,” measure “lifetime_spend” with a natural language description “Gross customer lifetime spend inclusive of taxes.”). According to various example embodiments, metadata extracted from the non-compatible semantic data 700 includes the natural language description provided for each of the measures 708.

FIG. 8 illustrates an example of compatible semantic data 802 that can be generated by a semantic data translation system, according to some example embodiments of the present disclosure. As shown, graphical user interface 800 presents the compatible semantic data 802 generated by a semantic data translation system based on a data store schema of a data store (e.g., database). The compatible semantic data 802 provides table information 804 specifying a logical table (named “CUSTOMERS”), includes a natural language description 806 for the table, includes base table information 808 for an underlying table (CUSTOMERS table of the ANALYTICS schema of the CATRANSLATOR database) associated with the logical table “CUSTOMERS,” and includes dimension information 810 for dimensions. As shown, the dimension information 810 identifies a dimension named “CUSTOMER_ID,” includes a natural language description 812 for the “CUSTOMER_ID” dimension, includes an SQL expression 814 “customer_id,” includes a TEXT data type 816, and includes sample values 818 from the underlying table specified by the base table information 808. Using the graphical user interface 800, a user (e.g., engineer) can select graphical user interface element 820 to cause the compatible semantic data 802 to be validated (e.g., to confirm proper formatting and compatibility with the target data system). The validation status of the compatible semantic data 802 can be displayed by graphical user interface element 824. The user can also select graphical user interface element 822 to start (e.g., invoke) the process for integrating (e.g., merging) of metadata from non-compatible data into the compatible semantic data 802.

FIG. 9A and FIG. 9B illustrate an example graphical user interface 900 that can be used with various example embodiments of the present disclosure. Graphical user interface 900 can represent a graphical user interface displayed to a user at a client device (e.g., 112) when they start the integration (e.g., merger) process, such via graphical user interface element 822 of graphical user interface 800 of FIG. 8. Graphical user interface 900 provides an interface to compare metadata field-by-field for non-compatible data (e.g., a DBT file selected and uploaded to the semantic data translation system) and compatible semantic data. Through graphical user interface 900, the user can review the comparison of the non-compatible data and the compatible semantic data, and can merge select metadata from the non-compatible data to the compatible semantic data. The user can fine-tune specific merger options, and approve the final merger of the metadata.

As shown, graphical user interface 900 comprises graphical user interface element 902 for selecting a logical table (e.g., “CUSTOMERS”) identified by compatible semantic data (e.g., 802), graphical user interface element 904 for selecting an entity (e.g., “customer”) identified by non-compatible data (e.g., non-compatible semantic data 700), graphical user interface element 906 for selecting which source (e.g., “PARTNER” representing the non-compatible data or “CORTEX” representing the compatible semantic data) should be used in merger for common metadata when fields (e.g., structural elements) are shared in both sources, and graphical user interface elements 908 for selecting unmatched fields (e.g., structural elements) from which sources should be retained in the compatible semantic data. Section 910 of graphical user interface 900 lists dimensions (dimensions 914, 916) of the compatible semantic data, and section 912 of graphical user interface 900 lists measures (measures 918, 920) of the compatible semantic data. Through graphical user interface 900, a user can select, for a given field (structural element) of the compatible semantic data, whether to use metadata from the non-compatible data (e.g., represented by “PARTNER”), whether to use metadata already present in the compatible semantic data (e.g., represented by “CORTEX”), whether to use metadata from a default source preference selected by graphical user interface element 906 (e.g., represented by “merged”), and whether to remove the field (structural element). In graphical user interface 900, user selection of these options is facilitated through graphical user interface elements 922 for dimension 914, graphical user interface elements 924 for dimension 916, graphical user interface elements 926 for measure 918, and graphical user interface elements 928 for measure 920.

FIG. 10 illustrates a diagrammatic representation of a machine 1000 in the form of a computer system within which a set of instructions can be executed for causing the machine 1000 to perform any one or more of the methodologies discussed herein, according to some example embodiments of the present disclosure. Specifically, FIG. 10 shows a diagrammatic representation of the machine 1000 in the example form of a computer system, within which instructions 1010 (e.g., software, a program, an application, an applet, an app, or other executable code) for causing the machine 1000 to perform any one or more of the methodologies discussed herein can be executed. For example, the instructions 1010 may cause the machine 1000 to execute any one or more operations of any one or more of the methods described herein. As another example, the instructions 1010 may cause the machine 1000 to implement portions of the data flows described herein. In this way, the instructions 1010 transform a general, non-programmed machine into a particular machine 1000 (e.g., the compute service manager 106, the execution platform 108, client device 112) that is specially configured to carry out any one of the described and illustrated functions in the manner described herein.

In alternative embodiments, the machine 1000 operates as a standalone device or can be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1010, sequentially or otherwise, that specify actions to be taken by the machine 1000. Further, while only a single machine 1000 is illustrated, the term “machine” shall also be taken to include a collection of machines machine 1000 that individually or jointly execute the instructions 1010 to perform any one or more of the methodologies discussed herein.

The machine 1000 includes processors 1004, memory 1012, and input/output (I/O) components 1022 configured to communicate with each other such as via a bus 1002. In an example embodiment, the processors 1004 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1006 and a processor 1008 that may execute the instructions 1010. The term “processor” is intended to include multi-core processors 1004 that may comprise two or more independent processors (sometimes referred to as “cores”) that may execute instructions 1010 contemporaneously. Although FIG. 10 shows multiple processors 1004, the machine 1000 may include a single processor with a single core, a single processor with multiple cores (e.g., a multi-core processor), multiple processors with a single core, multiple processors with multiple cores, or any combination thereof.

The memory 1012 may include a main memory 1014, a static memory 1016, and a storage unit 1018, all accessible to the processors 1004 such as via the bus 1002. The main memory 1014, the static memory 1016, and the storage unit 1018 comprising a machine storage medium 1020 may store the instructions 1010 embodying any one or more of the methodologies or functions described herein. The instructions 1010 may also reside, completely or partially, within the main memory 1014, within the static memory 1016, within the storage unit 1018, within at least one of the processors 1004 (e.g., within the processor's cache memory), or any suitable combination thereof, during execution thereof by the machine 1000.

The I/O components 1022 include components to receive input, provide output, produce output, transmit information, exchange information, capture measurements, and so on. The specific I/O components 1022 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1022 may include many other components that are not shown in FIG. 10. The I/O components 1022 are grouped according to functionality merely for simplifying the following discussion and the grouping is in no way limiting. In various example embodiments, the I/O components 1022 may include output components 1024 and input components 1026. The output components 1024 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication can be implemented using a wide variety of technologies. The I/O components 1022 may include communication components 1028 operable to couple the machine 1000 to a network 1032 via a coupling 1036 or to devices 1030 via a coupling 1034. For example, the communication components 1028 may include a network interface component or another suitable device to interface with the network 1032. In further examples, the communication components 1028 may include wired communication components, wireless communication components, cellular communication components, and other communication components to provide communication via other modalities. The devices 1030 can be another machine or any of a wide variety of peripheral devices (e.g., a peripheral device coupled via a universal serial bus (USB)). For example, as noted above, the machine 1000 may correspond to any client device, the compute service manager 106, the execution platform 108, and the devices 1030 may include any other of these systems and devices.

The various memories (e.g., 1012, 1014, 1016, and/or memory of the processor(s) 1004 and/or the storage unit 1018) may store one or more sets of instructions 1010 and data structures (e.g., software) embodying or utilized by any one or more of the methodologies or functions described herein. These instructions 1010, when executed by the processor(s) 1004, cause various operations to implement the disclosed embodiments.

As used herein, the terms “machine-storage medium,” “device-storage medium,” and “computer-storage medium” mean the same thing and can be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1032 can be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1032 or a portion of the network 1032 may include a wireless or cellular network, and the coupling 1036 can be a Code Division Multiple Access (CDMA) connection, a Global System for Mobile communications (GSM) connection, or another type of cellular or wireless coupling. In this example, the coupling 1036 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1010 can be transmitted or received over the network 1032 using a transmission medium via a network interface device (e.g., a network interface component included in the communication components 1028) and utilizing any one of a number of well-known transfer protocols (e.g., hypertext transfer protocol (HTTP)). Similarly, the instructions 1010 can be transmitted or received using a transmission medium via the coupling 1034 (e.g., a peer-to-peer coupling) to the devices 1030. The terms “transmission medium” and “signal medium” mean the same thing and can be used interchangeably in this disclosure. The terms “transmission medium” and “signal medium” shall be taken to include any intangible medium that is capable of storing, encoding, or carrying the instructions 1010 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: accessing source non-compatible data that describes a data store schema of a select data store using a non-compatible structural format; determining a set of non-compatible structural elements in the source non-compatible data; mapping the set of non-compatible structural elements to a first set of compatible structural elements that uses a semantic structural format to describe the data store schema; accessing or generating target compatible semantic data describing the data store schema using the semantic structural format; determining, in the target compatible semantic data, a second set of compatible structural elements that corresponds to the first set of compatible structural elements; and merging at least a portion of metadata from the source non-compatible data into the target compatible semantic data, the merging of the portion of metadata comprising: using the first set of compatible structural elements to compare first metadata from the source non-compatible data for the set of non-compatible structural elements with second metadata from the target compatible semantic data for the second set of compatible structural elements.

In Example 2, the subject matter of Example 1 includes, wherein the non-compatible structural format is not compatible for use by the target data system to generate one or more structured language data queries for the select data store based on a natural language question, and wherein is compatible for use by the target data system to generate the one or more structured language data queries for the select data store based on the natural language question.

In Example 3, the subject matter of Examples 1-2 includes, wherein the generating of the target compatible semantic data comprises: extracting, from the select data store, metadata for at least one of a table, a view, or a column of the select data store identified by the data store schema; and using a large-language model to generate, for the target compatible semantic data, a natural language description of the at least one of the table, the view, or the column based on the extracted metadata.

In Example 4, the subject matter of Examples 1-3 includes, wherein the generating of the target compatible semantic data comprises: obtaining, from the select data store, a select number of sample values from a column of a table of the select data store identified by the data store schema; and using a set of large-language models to generate, for the target compatible semantic data, a natural language description of the column of the table of the select data store based on the select number of sample values.

In Example 5, the subject matter of Examples 1˜4 includes, wherein the generating of the target compatible semantic data comprises: mapping a column of a table of the select data store to at least one of a non-time logical dimension, a time dimension logical column, or a measure logical column in the target compatible semantic data based on a data type of the column, the non-time dimension logical column being capable of storing a categorical value, the time dimension logical column being capable of storing a time value, date value, or both, and the measure logical column being capable of storing a numerical value.

In Example 6, the subject matter of Examples 1-5 includes, wherein the generating of the target compatible semantic data comprises: validating the target compatible semantic data to confirm proper formatting and compatibility with the target data system.

In Example 7, the subject matter of Examples 1-6 includes, wherein the set of non-compatible structural elements comprises at least one of an entity, a measure, or a dimension.

In Example 8, the subject matter of Examples 1-7 includes, wherein the operations comprise: receiving a user selection that comprises a selection of the data store schema of the select data store.

In Example 9, the subject matter of Example 8 includes, wherein the selection is a first selection, and wherein the user selection comprises a second selection of one or more tables of the data store.

In Example 10, the subject matter of Examples 1-9 includes, wherein the using of the first set of compatible structural elements to compare the first metadata with the second metadata comprises: matching a first compatible structural element of the first set of compatible structural elements with a second compatible structural element of the second set of compatible structural elements, the first compatible structural element corresponding to a select non-compatible structural element of the set of non-compatible structural elements; and wherein the merging of the portion of metadata comprises: determining whether the source non-compatible data contains select metadata associated with the select non-compatible structural element; and in response to determining that the source non-compatible data contains the select metadata, replacing, in the target compatible semantic data, existing metadata for the second compatible structural element with the select metadata from the source non-compatible data.

In Example 11, the subject matter of Examples 1-10 includes, wherein the using of the first set of compatible structural elements to compare the first metadata with the second metadata comprises: matching a first compatible structural element of the first set of compatible structural elements with a second compatible structural element of the second set of compatible structural elements, the first compatible structural element corresponding to a select non-compatible structural element of the set of non-compatible structural elements; and wherein the merging of the portion of metadata comprises: determining whether the source non-compatible data contains select metadata associated with the select non-compatible structural element; and in response to determining that the source non-compatible data does not contain the select metadata, retaining, in the target compatible semantic data, existing metadata for the second compatible structural element.

In Example 12, the subject matter of Examples 1-11 includes, wherein the source non-compatible data is generated or managed by a third-party software tool.

Example 13 is a method to implement any of Examples 1-12.

Example 14 is a machine-storage medium, the machine-storage medium including instructions that when executed by a machine, cause the machine to perform operations to implement any of Examples 1-12.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various example embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various example embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
accessing source non-compatible data that describes a data store schema of a select data store using a non-compatible structural format;
determining a set of non-compatible structural elements in the source non-compatible data;
mapping the set of non-compatible structural elements to a first set of compatible structural elements that uses a semantic structural format to describe the data store schema;
accessing or generating target compatible semantic data describing the data store schema using the semantic structural format;
determining, in the target compatible semantic data, a second set of compatible structural elements that corresponds to the first set of compatible structural elements; and
merging at least a portion of metadata from the source non-compatible data into the target compatible semantic data, the merging of the portion of metadata comprising:
using the first set of compatible structural elements to compare first metadata from the source non-compatible data for the set of non-compatible structural elements with second metadata from the target compatible semantic data for the second set of compatible structural elements.

2. The system of claim 1, wherein the non-compatible structural format is not compatible for use by the target data system to generate one or more structured language data queries for the select data store based on a natural language question, and wherein is compatible for use by the target data system to generate the one or more structured language data queries for the select data store based on the natural language question.

3. The system of claim 1, wherein the generating of the target compatible semantic data comprises:
extracting, from the select data store, metadata for at least one of a table, a view, or a column of the select data store identified by the data store schema; and
using a large-language model to generate, for the target compatible semantic data, a natural language description of the at least one of the table, the view, or the column based on the extracted metadata.

4. The system of claim 1, wherein the generating of the target compatible semantic data comprises:
obtaining, from the select data store, a select number of sample values from a column of a table of the select data store identified by the data store schema; and
using a set of large-language models to generate, for the target compatible semantic data, a natural language description of the column of the table of the select data store based on the select number of sample values.

5. The system of claim 1, wherein the generating of the target compatible semantic data comprises:
mapping a column of a table of the select data store to at least one of a non-time logical dimension, a time dimension logical column, or a measure logical column in the target compatible semantic data based on a data type of the column, the non-time dimension logical column being capable of storing a categorical value, the time dimension logical column being capable of storing a time value, date value, or both, and the measure logical column being capable of storing a numerical value.

6. The system of claim 1, wherein the generating of the target compatible semantic data comprises:
validating the target compatible semantic data to confirm proper formatting and compatibility with the target data system.

7. The system of claim 1, wherein the set of non-compatible structural elements comprises at least one of an entity, a measure, or a dimension.

8. The system of claim 1, wherein the operations comprise:
receiving a user selection that comprises a selection of the data store schema of the select data store.

9. The system of claim 8, wherein the selection is a first selection, and wherein the user selection comprises a second selection of one or more tables of the data store.

10. The system of claim 1, wherein the using of the first set of compatible structural elements to compare the first metadata with the second metadata comprises:
matching a first compatible structural element of the first set of compatible structural elements with a second compatible structural element of the second set of compatible structural elements, the first compatible structural element corresponding to a select non-compatible structural element of the set of non-compatible structural elements; and
wherein the merging of the portion of metadata comprises:
determining whether the source non-compatible data contains select metadata associated with the select non-compatible structural element; and
in response to determining that the source non-compatible data contains the select metadata, replacing, in the target compatible semantic data, existing metadata for the second compatible structural element with the select metadata from the source non-compatible data.

11. The system of claim 1, wherein the using of the first set of compatible structural elements to compare the first metadata with the second metadata comprises:
matching a first compatible structural element of the first set of compatible structural elements with a second compatible structural element of the second set of compatible structural elements, the first compatible structural element corresponding to a select non-compatible structural element of the set of non-compatible structural elements; and
wherein the merging of the portion of metadata comprises:
determining whether the source non-compatible data contains select metadata associated with the select non-compatible structural element; and
in response to determining that the source non-compatible data does not contain the select metadata, retaining, in the target compatible semantic data, existing metadata for the second compatible structural element.

12. The system of claim 1, wherein the source non-compatible data is generated or managed by a third-party software tool.

13. A method comprising:
accessing, by at least one processor, source non-compatible data that describes a data store schema of a select data store using a non-compatible structural format;
determining, by the at least one processor, a set of non-compatible structural elements in the source non-compatible data;
mapping, by the at least one processor, the set of non-compatible structural elements to a first set of compatible structural elements that uses a semantic structural format to describe the data store schema;
accessing or generating, by the at least one processor, target compatible semantic data describing the data store schema using the semantic structural format;
determining, by the processor, in the target compatible semantic data, a second set of compatible structural elements that corresponds to the first set of compatible structural elements; and
merging, by the at least one processor, at least a portion of metadata from the source non-compatible data into the target compatible semantic data, the merging of the portion of metadata comprising:
using the first set of compatible structural elements to compare first metadata from the source non-compatible data for the set of non-compatible structural elements with second metadata from the target compatible semantic data for the second set of compatible structural elements.

14. The method of claim 13, wherein the generating of the target compatible semantic data comprises:
extracting, from the select data store, metadata for at least one of a table, a view, or a column of the select data store identified by the data store schema; and
using a large-language model to generate, for the target compatible semantic data, a natural language description of the at least one of the table, the view, or the column based on the extracted metadata.

15. The method of claim 13, wherein the generating of the target compatible semantic data comprises:
obtaining, from the select data store, a select number of sample values from a column of a table of the select data store identified by the data store schema; and
using a set of large-language models to generate, for the target compatible semantic data, a natural language description of the column of the table of the select data store based on the select number of sample values.

16. The method of claim 13, wherein the generating of the target compatible semantic data comprises:
mapping a column of a table of the select data store to at least one of a non-time logical dimension, a time dimension logical column, or a measure logical column in the target compatible semantic data based on a data type of the column, the non-time dimension logical column being capable of storing a categorical value, the time dimension logical column being capable of storing a time value, date value, or both, and the measure logical column being capable of storing a numerical value.

17. The method of claim 13, wherein the set of non-compatible structural elements comprise at least one of an entity, a measure, or a dimension.

18. The method of claim 13, comprising:
receiving, by the processor, a user selection that comprises a selection of the data store schema.

19. The method of claim 13, wherein the using of the first set of compatible structural elements to compare the first metadata with the second metadata comprises:
matching a first compatible structural element of the first set of compatible structural elements with a second compatible structural element of the second set of compatible structural elements, the first compatible structural element corresponding to a select non-compatible structural element of the set of non-compatible structural elements; and
wherein the merging of the portion of metadata comprises:
determining whether the source non-compatible data contains select metadata associated with the select non-compatible structural element; and
in response to determining that the source non-compatible data contains the select metadata, replacing, in the target compatible semantic data, existing metadata for the second compatible structural element with the select metadata from the source non-compatible data.

20. A machine-storage medium, the machine-storage medium including instructions that when executed by a machine, cause the machine to perform operations comprising:
accessing source non-compatible data that describes a data store schema of a select data store using a non-compatible structural format;
determining a set of non-compatible structural elements in the source non-compatible data;
mapping the set of non-compatible structural elements to a first set of compatible structural elements that uses a semantic structural format to describe the data store schema;
accessing or generating target compatible semantic data describing the data store schema using the semantic structural format;
determining, in the target compatible semantic data, a second set of compatible structural elements that corresponds to the first set of compatible structural elements; and
merging at least a portion of metadata from the source non-compatible data into the target compatible semantic data, the merging of the portion of metadata comprising:
using the first set of compatible structural elements to compare first metadata from the source non-compatible data for the set of non-compatible structural elements with second metadata from the target compatible semantic data for the second set of compatible structural elements.
